(19) United States
(12) Patent Application Publication
(10) Pub. No.: US 2009/0286878 A1
(43) Pub. Date: Nov. 19, 2009

(54) POLYOL DERIVED ANTI-MICROBIAL AGENTS AND COMPOSITIONS

(76) Inventors: Stewart Todd Elder, Butler, NJ (US); Fadi Khawam, Norwood, NJ (US); Xinyu Huang, Parsippany, NJ (US); Werner Holzl, Eschentzwiller (FR)

Correspondence Address: JoAnn Villamizar;Ciba Corporation/Patent Department, 540 White Plains Road, P.O. Box 2005, Tarrytown, NY, 10591, US

(21) Appl. No.: 12/465,799

(22) Filed: May 14, 2009

Related U.S. Application Data
(60) Provisional application No. 61/127,558, filed on May 14, 2008.

(51) Int. Cl. A01N 37/12; A01P 1/00

(52) U.S. Cl. 514/551

(57) ABSTRACT

Anti-microbial compositions are provided which comprise as an antimicrobial agent at least one compound derived from a select polyol containing at least 3 hydroxy groups wherein one or more, and often two or more, of the hydroxyls are derivitized to form certain ether, ester, carbonate or carbamate groups which groups may bear additional functionality. Novel antimicrobial compounds of this class are also provided. The compositions are effective against a variety of pathogens including fungi, Gram positive bacteria and Gram negative bacteria and are expected to have low human toxicity. Applications for the polyglycerol anti-microbial agents and compositions include those involving human and plant contact, such as cosmetics, hair care products, textiles and plant protections, as well as in applications with much less human contact, such as plastics, coatings, wood, paper and other materials of construction.

This application claims benefit under 35 USC 119(e) of U.S. provisional application No. 61/127,558, filed May 14, 2008, incorporated herein in its entirety by reference.

The preparation and use of compositions containing as anti-microbial agents derivatives of select polyols wherein one or more, and often two or more, of the polyol hydroxyls are derivatized with certain ether, ester, carbonate or carbamate groups are provided. The agents are believed to have low human and animal toxicity while being effective against a variety of pathogens and are useful in applications involving human contact, for example cosmetics, hair care products, textiles and surface treatments such as encountered in plant protection, household surface treatments etc, as well as in applications with much less human contact, such as coatings and plastics.

Anti-microbial compounds are widely used and accepted as part of numerous commercial products and materials. Anti-bacterial soaps, anti-fungal treatments for plants, topical medical treatments, anti-fouling coatings and disinfecting cleaners are just a few common uses of anti-microbial materials.

U.S. Pat. Nos. 6,090,772; 5,955,408; 6,071,866; 6,358,906, incorporated herein in their entirety by reference, and WO96/06152 disclose compositions useful in personal care applications comprising triclosan as an anti-bacterial agent.

U.S. Pat. No. 5,635,462, incorporated herein in its entirety by reference, also discloses compositions comprising an anti-bacterial agent.

WO98/55096 discloses antimicrobial wipes having a porous sheet impregnated with an antibacterial composition containing an active antimicrobial agent.

U.S. Pat. No. 6,861,397, incorporated herein in its entirety by reference, discloses personal care and cleaning compositions having enhanced deposition of a topically active compound including antibacterial agents.

US Published Pat. Appl. 20070265267, incorporated herein in its entirety by reference, discloses synergistic fungicidal compositions and a method of controlling phytopathogenic diseases on useful plants or on propagation material thereof, which comprises applying to the useful plants, the locus thereof or propagation material thereof the synergistic fungicidal composition.

Co pending U.S. patent application Ser. No. 11/656,863, incorporated herein in its entirety by reference, discloses substituted polyethylenimines effective as antimicrobial agents.

Co pending U.S. patent application Ser. No. 12/283,067, incorporated herein in its entirety by reference, discloses substituted polyglycerols effective as antimicrobial agents.

Co pending U.S. patent application Ser. No. 10/565,545 incorporated herein in its entirety by reference, discloses substituted 2,4-bis(alkylamino)pyrimidines in the antimicrobial treatment of surfaces and to the preparation of such compounds.

It is important that anti-microbial compounds, such as those found in antifungal and antibacterial compositions, provide a substantial and broad spectrum reduction in microorganism populations quickly and without problems associated with toxicity and skin irritation. In many cases, it is desirable to maintain anti-microbial activity long after application of the antimicrobial agent.

Polyol derivatives have been identified which are effective anti-microbial compounds against a wide spectrum of microbes including fungi, gram positive bacteria and gram negative bacteria. They are quite effective in protecting surfaces including the surfaces of synthetic polymers, e.g., plastics and coatings, and natural polymers, e.g., wood, cotton etc. They are also active against many common fungi such as those affecting human skin and scalp and many plants, for example, the polymers are effective anti-dandruff and plant protection agents.

### DESCRIPTION OF THE INVENTION

Provided are anti-microbial compositions comprising ether, ester, carbonate or carbamate derivatives of polyols as anti-microbial agents, also referred to herein as anti-microbial compounds, and methods for their use. That is, the anti-microbial agents of the invention are derived from organic compounds containing from 3 to 6 hydroxyl groups wherein one or more, often two or more, and typically 3 or more, of the hydroxyls have been functionalized resulting in certain ether, ester, carbonate or carbamate groups. The anti-microbial agents are used to kill microbes on contact as in disinfection applications as well as preserve and protect materials against microbe infestation.

The compositions of the of the present invention comprise one or more anti-microbial agents of the general formula I

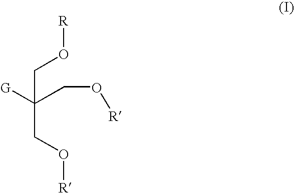

wherein G is H or C₁₋₁₂ alkyl, for example methyl, ethyl or a group CH2-OR′,

wherein each R′ is independently H or a group R, often at least one R′ is a group R as in formula Ia or Ib,

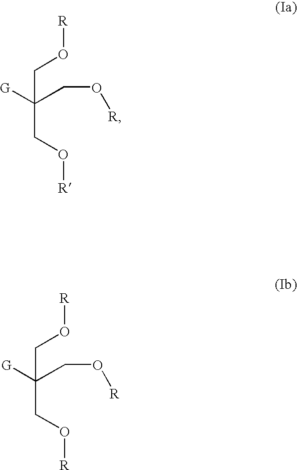

and each R is independently a substituted or unsubstituted alkyl, alkenyl, alkyl carbonyl or alkenyl carbonyl, which are incorporated into a home or personal care formulation, plant protection formulation, a natural or synthetic polymer, a coating or other material of construction.

For example, the antimicrobial agents are compounds of formula I, Ia or Ib wherein

G is H or C₁₋₁₂ alkyl, for example methyl, ethyl or a group CH2-OR′,

each R′ is independently H or a group R, and

each R is independently selected from C₁₋₂₄ alkyl, C₃₋₂₄ alkenyl, C₁₋₂₄ alkylcarbonyl and C₃₋₂₄ alkenylcarbonyl which are uninterrupted or interrupted one or more times by one or more —O—, —N(R″)—, —CON(R″)—, and are unsubstituted or substituted one or more times by one or more C₃₋₆ cycloalkyl, —OR″, —COOR″, —COOM, —SO₃M, —SO₃H, phosphonic acid, halogen, —CONR″R″, —NR″R″, phosphonate salt, ammonium salt, group of the formulae

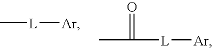

or group —Si(Y)₃ wherein each Y is independently hydroxyl, C₁₋₄ alkyl or C₁₋₄ alkoxy;

wherein each R″, independently of any other R″ is H, C₁₋₂₄ alkyl, C₃₋₂₄ alkenyl, C₃₋₆ cycloalkyl or C₁₋₂₄ alkylcarbonyl which are uninterrupted or interrupted one or more times by one or more oxygen atoms, carbonyl, —COO—, —CONH—, —NH—, —CON(C₁₋₂₄ alkyl)- or —N(C₁₋₂₄ alkyl)-,

which uninterrupted or interrupted alkyl, alkenyl, cycloalkyl or alkylcarbonyl are unsubstituted or substituted one or more times by one or more groups selected from halogen, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(₁₋₂₄ alkyl), —N(C₁₋₂₄ alkyl)₂, —SO₃M, phenyl, phenyl substituted one or more times by one or more C₁₋₈ alkyl, naphthyl, naphthyl substituted one or more times by one or more C₁₋₈ alkyl, ammonium salt, phosphonic acid, phosphonate salt

or

when two R″ are attached to a nitrogen atom they may form, together with the nitrogen atom to which they are attached, form a 5-, 6- or 7-membered ring which is uninterrupted or interrupted by —O—, —NH— or —N(C₁₋₁₂ alkyl)-;

or R″ is a group -L-Ar,

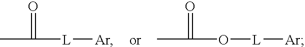

L is a direct bond, C₁₋₁₂ alkylene which is uninterrupted or interrupted by one or more oxygen atoms, —NH—, —N(C₁₋₁₂ alkyl) or phenylene, and/or unsubstituted or substituted one or more times by one or more —OH, C₁₋₈ alkyl, C₁₋₂₄ alkoxy, C₂₋₂₄alkylcarboxy, —NH₂, —N(H)(C₁₋₈ alkyl), —N(C₁₋₈ alkyl)₂ or ammonium salt;

Ar is C₆₋₁₀ aromatic or C₁₋₉ saturated or unsaturated heterocycle, which C₆₋₁₀ aromatic or C₁₋₉ saturated or unsaturated heterocycle are unsubstituted or substituted one or more times by one or more halogen, —OH, C₁₋₂₄ alkoxy, C₂₋₂₄ alkylcarboxy, —COOQ, —CONH₂, —CON(H)(C₁₋₈ alkyl), —CON(C₁₋₈ alkyl)₂, —NH₂, —N(H)(C₁₋₈ alkyl), —N(C₁₋₈ alkyl)₂, —SO₃M, SO₃H, ammonium salt, phosphonic acid, phosphonate salt, C₁₋₂₄ alkyl, C₁₋₂₄ alkyl substituted one or more times by one or more halogen, wherein Q is hydrogen, C₁₋₂₄ alkyl, metal cation, ammonium salt, glycol ether, phenyl or benzyl, or phenyl or benzyl substituted one or more times by one or more halogen, hydroxy, C₁₋₂₄ alkoxy or C₁₋₁₂ alkyl; and

M is a metal cation or an ammonium cation.

Alkyl is a straight or branched chain of the specified number of carbon atoms and is for example methyl, ethyl, n-propyl, n-butyl, sec-butyl, tert-butyl, n-hexyl, n-octyl, 2-ethylhexyl, n-nonyl, n-decyl, n-undecyl, n-dodecyl, n-tridecyl, n-tetradecyl, n-hexadecyl, n-octadecyl or docosanyl and the like.

Alkenyl is a straight or branched chain of the specified number of carbon atoms containing one or more carbon-carbon double bonds and is for example n-propenyl, n-butenyl, sec-butenyl, n-hexenyl, n-octenyl, n-hexadienyl, n-octadienyl, 2-ethythexenyl, n-nonenyl, n-decenyl, n-undecenyl, n-dodecenyl, n-tridecenyl, n-tetradecenyl, n-hexadecenyl, n-octadecenyl, n-dodecadienyl, n-tetradecadienyl, n-hexadecadienyl, n-hexadecatrienyl, n-octadecadienyl, n-octadecatrienyl.

Alkyl carbonyl or alkanoyl is a straight or branched chain of the specified number of carbon atoms which has a carbonyl at the point of attachment.

C₁₋₉ saturated or unsaturated heterocycle is a monocyclic or polycyclic ring of at least 3 atoms, containing 1-9 carbon atoms which heterocycle may also be ionically charged.

For example, C₁₋₉ saturated or unsaturated heterocycle is a 5, 6, or 7 membered ring containing 1, 2 or 3 heteroatoms (non-carbon atoms) for example, 1, 2 or 3 nitrogen atoms, oxygen atoms, sulfur atoms, phosphorous atoms or a mixture of 2 or 3 heteroatoms which ring may be fused to another carbocyclic or heterocyclic ring;

for example, C₁₋₉ saturated or unsaturated heterocycle is a 5, 6, or 7 membered ring containing 1, 2 or 3 nitrogen atoms, oxygen atoms or a mixture of nitrogen and oxygen atoms which may be fused to a benzene ring;

for example, C₁₋₉ saturated or unsaturated heterocycle is a purine, imidazole, pyridine, pyramidine or triazole ring;

wherein the heterocyle may be substituted by common groups such as halogen, hydroxy, alkyl, alkoxy, haloalkyl, alkylcarbonyl, alkylcarbonyloxy, amino, amido etc, and which heterocycle may also be ionically charged.

An ammonium salt is, for example, unsubstituted ammonium, ammonium substituted 1, 2 or 3 times by one or more groups selected from

C₆₋₁₀aryl, C₁₋₂₄alkyl, C₁₋₂₄branched alkyl, C₁₋₂₄alkyl and branched alkyl interrupted by one or more oxygen atoms, carbonyl, carboxy or C₆₋₁₀arylene,

and said aryl, alkyl, branched alkyl, interrupted alkyl and interrupted branched alkyl substituted by alkyl, aryl, OH, OAlkyl, OAcyl; plus a corresponding counter anion.

The ammonium salt may also comprise a ring or polycycle, which ring or polycycle may be substituted.

For example, the ammonium salt is tris benzyl ammonium or mono-, di-, or tri-C₁₋₂₄alkylammonium wherein each alkyl group can be the same or different, mono-, di-, or tri-benzyl, mono-, di-, or tri-C₁₋₂₄hydroxyalkylammonium wherein each alkyl group can be the same or different.

For example, the ammonium salt is di- or tri-substituted ammonium wherein each of the substituents are independently chosen from C₁₋₂₄alkyl, benzyl and C₁₋₂₄hydroxyalkyl.

The C₁₋₂₄alkyl, benzyl and C₁₋₂₄hydroxyalkyl groups of the substituted ammonium salts, may also be substituted by one or more C₁₋₈alkyl or branched alkyl, hydroxy, C₁₋₂₄carboxy ester, C₁₋₂₄alkyloxy, C₁₋₂₄acyloxy or halogen.

When M is an ammonium cation, it is for example, unsubstituted ammonium, ammonium substituted 1, 2, 3 or 4 times by one or more groups selected from C₁₋₂₄alkyl, C₁₋₂₄branched alkyl, said alkyl and branched alkyl interrupted by one or more oxygen atoms, C₆₋₁₀aryl, C₇₋₉ aralkyl, and said alkyl, branched alkyl, interrupted alkyl and interrupted branched alkyl, and aryl substituted by alkyl, OH, OC₁₋₂₄alkyl, OC₁₋₂₄acyl.

In one embodiment, G in formula I is methyl, ethyl or CH₂—OR′ wherein R′ is not hydrogen, i.e., a group CH₂—OR. In one embodiment the compound of formula I is compound of formula Id, II or III:

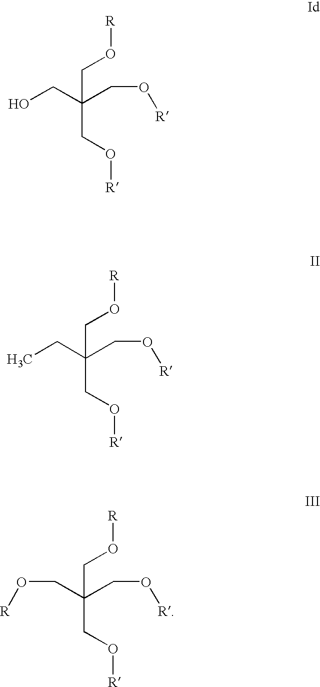

In another embodiment, the compound of formula I is compound of formula II or III wherein one of R′ is an R group as defined above, in another embodiment, the compound of formula I is compound of formula II or III wherein each R′ is independently an R group as defined above.

In another embodiment, G is the group CH₂—OR′ wherein R′ is a branched alkyl substituted by more than one group OR″ wherein R″ is as defined above, for example a branched, five carbon alkyl group, for example, neopentyl, substituted by three groups OR″, for example, R′ is a group:

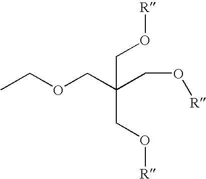

wherein each R″ is selected independently from each other. For example, in one embodiment the compound of formula I is compound of the formula IV,

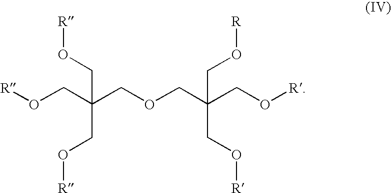

The anti-microbial compositions of the invention may comprise one or more than one compound of formula I, within each compound of formula I, the R, R′ and R″ groups may all be the same or different and a single R or R″ group may bear two or more different substituents.

For example, in one embodiment, the compositions of the of the present invention comprise as anti-microbial agent one or more compounds selected from the formulae Id, II, III and IV above, for example, compounds of formula IIa, IIb, IIIa, IIIb, IV and IVa,

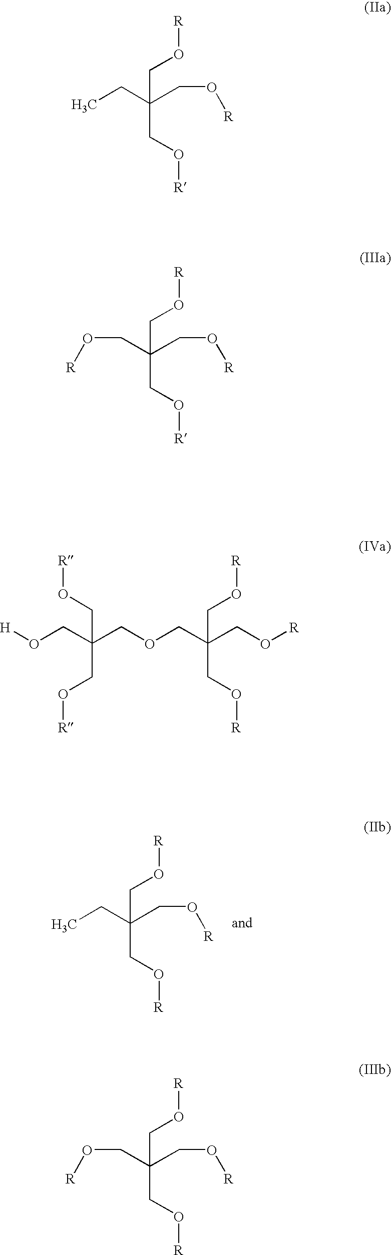

wherein in any of the formulae each R is independently C₁₋₂₄ alkyl or C₁₋₂₄ alkylcarbonyl which is uninterrupted or interrupted one or more times by —O—, —N(R″)— or —CON(R″)—, and unsubstituted or substituted by one or more —NR″R″, halogen, ammonium salt, —COOM, -L-Ar,

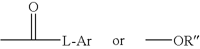

R′ is R″ and each R″, independently of any other R″ is H, C₁₋₂₄ alkyl, C₃₋₂₄ alkenyl or C₁₋₂₄ alkylcarbonyl which alkyl, alkenyl or alkylcarbonyl are uninterrupted or interrupted one or more times by one or more oxygen atoms, carbonyl, —COO—, —CONH—, —NH—,—CON(₁₋₂₄ alkyl)- or —N(C₁₋₂₄ alkyl)-, which uninterrupted or interrupted alkyl, alkenyl, or alkylcarbonyl are unsubstituted or substituted one or more times by one or more groups selected from halogen, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, —SO₃M, phenyl, phenyl substituted one or more times by one or more C₁₋₈ alkyl, naphthyl, naphthyl substituted one or more times by one or more C₁₋₈ alkyl, ammonium salt, phosphonic acid, phosphonate salt,

or when two R″ are attached to a nitrogen atom they may form, together with the nitrogen atom to which they are attached, form a 5-, 6- or 7-membered ring which is uninterrupted or interrupted by —O—, —NH— or —N(C₁₋₁₂ alkyl)-; or R″ is a group -L-Ar,

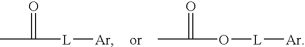

For example the compositions of the of the present invention comprise as anti-microbial agent one or more compounds selected from the formulae Id, II, III and IV, for example, compounds of formula IIa, IIb, IIIa, IIIb, IV and IVa wherein R is selected from C₁₋₂₄ alkyl and C₁₋₂₄ alkylcarbonyl which are uninterrupted or interrupted one or more times by —N(H)— or —N(R″)—, and/or substituted by one or more —NH₂, —NHR″, —NR″R″, halogen, ammonium salt, —COOM, —OH or —OR″,

R′ and R″ are independently hydrogen, C₁₋₂₄ alkyl or C₁₋₂₄ alkylcarbonyl which alkyl or alkylcarbonyl are uninterrupted or interrupted one or more times by one or more —O—, —NH— or —N(C₁₋₂₄ alkyl)-, and which uninterrupted or interrupted alkyl or alkylcarbonyl are unsubstituted or substituted one or more times by one or more groups selected from halogen, ammonium salt, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, phenyl, phenyl substituted one or more times by one or more C₁₋₈ alkyl, naphthyl and naphthyl substituted one or more times by one or more C₁₋₈ alkyl;

for example, R′ and R″ are independently hydrogen, C₁₋₂₄ alkyl or C₁₋₂₄ alkylcarbonyl, which alkyl or alkylcarbonyl are uninterrupted or interrupted one or more times by —O—, —NH— or —N(C₁₋₂₄ alkyl)-, and/or substituted one or more times by one or more groups selected from halogen, ammonium salt, —OH, C₁₋₂₄alkoxy, C₂₋₂₄alkylcarbonyl, —NH₂, —N(H)(C₁₋₂₄ alkyl) or —N(C₁₋₂₄ alkyl)₂.

For example, the compound of formula I is a compound of formulae

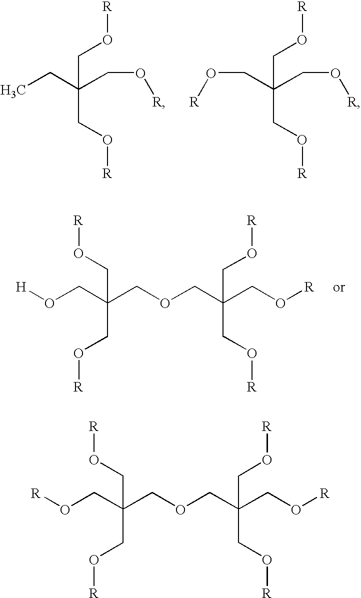

wherein R is selected from C₁₋₂₄ alkylcarbonyl interrupted by —NH— or —NR″—, and/or substituted one or more times by one or more —NH₂ or NHR″—NR″R″, wherein each R″ is independently C₁₋₂₄ alkyl or C₁₋₂₄ alkylcarbonyl.

In one embodiment of the invention, the antimicrobial agents are compounds of formula I of the following formulae:

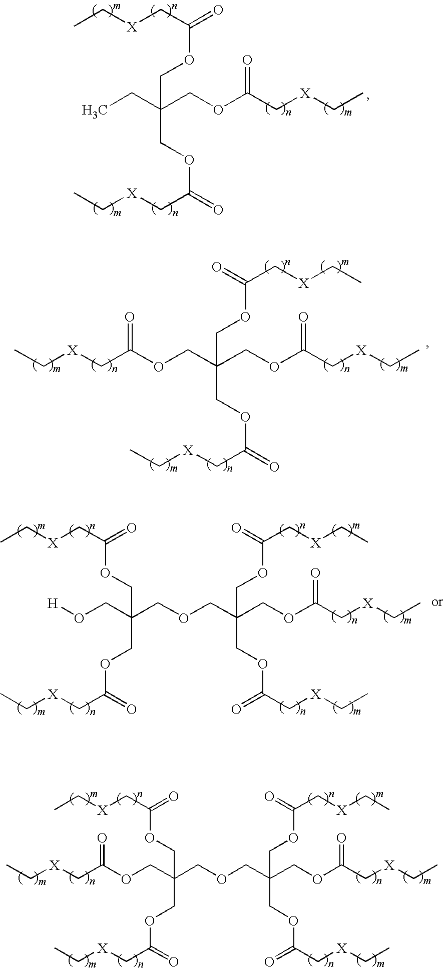

wherein each m is independently a number from 0 to 23, each n is independently a number from 1 to 23, for example, a number from 1 to 6, and X is —O—, —COO—, —NH—, —N(C₁₋₂₄ alkyl)-, —CONH— or —CON(C₁₋₂₄ alkyl)-, for example X is —NH— or —N(C₁₋₂₄ alkyl)-. When m is 0, a direct bond exists between x and the terminal methyl.

For example, the antimicrobial agents are compounds of formula I of the formulae:

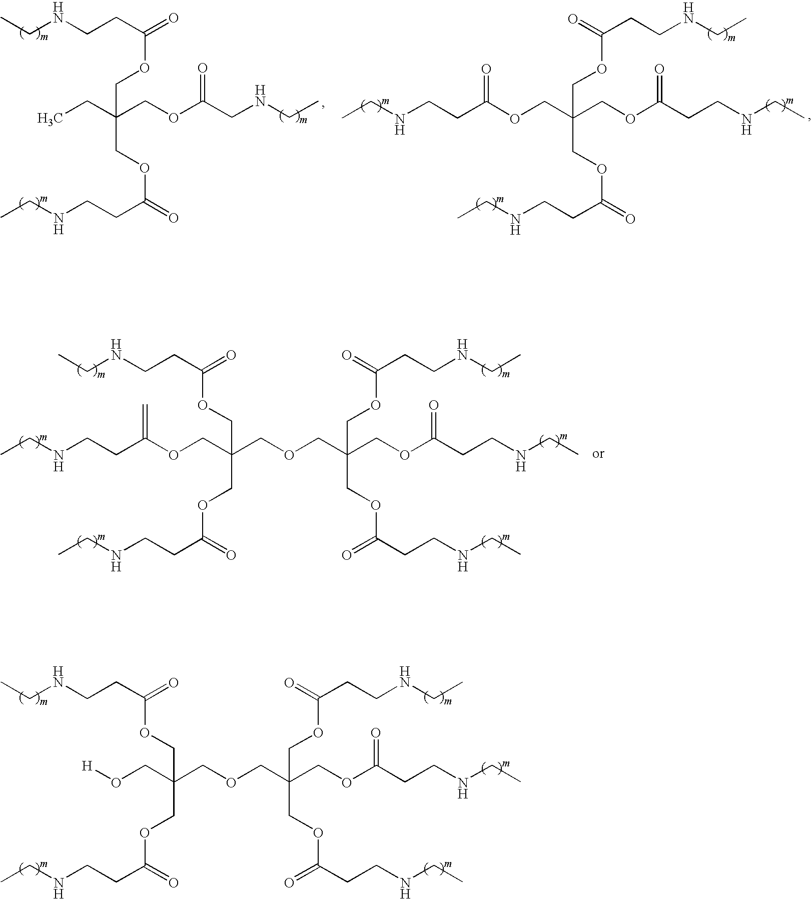

wherein each m is independently a number from 0-23, in one embodiment, each m is the same.

In another embodiment of the invention, the compound of formula I is a compound of the formula:

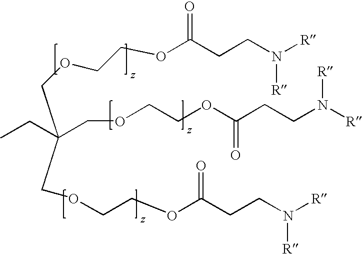

wherein z is 0, 1, 2 or 3 and each R″ is independently H or C₁₋₂₄ alkyl.

The anti-microbial agents may be substituted by one or more moieties that themselves provide antimicrobial properties. For example, two substituents may be present, one that is inherently anti-bacterial and another that is inherently anti-fungal.

Furthermore, a single R or R″ group can be multifunctional, for example, an alkyl or alkanoyl group which alkyl group is substituted by two moieties, one moiety conferring anti-bacterial activity and another moiety conferring anti-fungal activity. Such moieties may include substituents as found in co pending U.S. patent application Ser. Nos. 11/656,863 and 12/283,067, already incorporated herein in their entirety by reference.

In one embodiment, at least two different anti-microbial compounds of formula I are present in the composition.

In another embodiment, an anti-microbial compound of the present invention is blended with another anti-microbial compound, i.e., an anti-microbial compound not of formula I.

The anti-microbial compounds of the present invention are prepared, for example, from known polyols by derivatizing one or more, and often two or more of the hydroxy groups, often at least three hydroxy groups, through standard chemistry to introduce the selected R group generating, for example, ether, ester, carbonate, urea groups. Further modification of these introduced R groups may also be undertaken.

For example, hydroxy groups can be alkylated via reaction with alkyl halides, sulfonates, epoxides, etc. under the appropriate conditions, typically in the presence of a base. Alkylation also occurs via addition across a double bond as in reactions with vinyl esters, amides, nitriles sulphones etc. Hydroxyl groups can be acylated by reaction with acid halides, esters, anhydrides, carboxylic acids etc.

The reaction conditions will of course determine the amount of hydroxyl groups derivatized. In certain cases, derivation of two or more hydroxyl groups still leaves one or more free hydroxyl groups. For example, when alkylating the hydroxyl group with an alkyl mesylate, the amount of alkyl mesylate used in the reaction represents an upper limit of the amount of alkylating reagent that can be incorporated. In some embodiments, these compounds with free hydroxy groups are used as antimicrobial agents. In certain other embodiments, the free hydroxyl groups remaining after initial derivation are then reacted with another derivatizing agent to create a anti-microbial compound of formula I comprising different R groups.

Mixtures are possible from even a simple derivation reaction. For example, reaction with a polyol with a derivatizing agent may lead to a mixture of the wherein a portion of the polyol is derivatized on one hydroxyl and a portion of the polyol is derivatized on two hydroxyls. Any such combination of partially and fully derivatized polyols is possible.

It is also possible to prepare anti-microbial compounds of formula I comprising different R groups by reacting the starting polyols with a mixture of derivatizing agents. For example, a polyol may be acylated with an acyl halide, or a mixture of acyl halides.

As mentioned above, the polyol starting materials are typically commercially available compounds containing at least three hydroxy groups. For example, the following precursors to compounds of formulae II, III and IV are well known items of commerce:

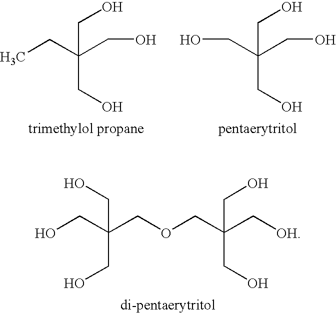

It is of course also possible to prepare non-commercial polyols via standard reactions for use as starting materials. It is also possible to introduce the groups OR of formula I by other well known means, for example, displacing a halide with an oxygen containing nuecleophile, or adding an oxygen containing reactant across a double bond.

The antimicrobial compounds of the invention exhibit pronounced antimicrobial action, for example, against pathogenic gram-positive and gram-negative bacteria and against bacteria of the skin flora, and also against yeasts and molds. They are suitable for disinfection, deodorisation, and for general and antimicrobial treatment of the skin and mucosa and of integumentary appendages (hair), for example, for the disinfection of hands and wounds.

They are suitable as antimicrobial active substances and preservatives in personal care preparations, for example shampoos, bath additives, hair care preparations, liquid and solid soaps (based on synthetic surfactants and salts of saturated and/or unsaturated fatty acids), lotions and creams, deodorants, other aqueous or alcoholic solutions, e.g. cleansing solutions for the skin, moist cleaning cloths, oils or powders.

For example, the antimicrobial compounds of the invention are effective as anti-dandruff agents in shampoos.

The invention accordingly relates also to a personal care preparation comprising at least one antimicrobial compound of the invention and cosmetically tolerable carriers or adjuvants.

The personal care preparation according to the invention contains from 0.01 to 15% by weight, for example, from 0.1 to 10% by weight, based on the total weight of the inventive composition, of the antimicrobial compounds of the invention, and cosmetically tolerable adjuvants.

Depending upon the form of the personal care preparation, it comprises, in addition to the antimicrobial compounds of the invention, further constituents, for example sequestering agents, colourings, perfume oils, thickening or solidifying agents (consistency regulators), emollients, UV-absorbers, skin protective agents, antioxidants, additives that improve the mechanical properties, such as dicarboxylic acids and/or aluminium, zinc, calcium or magnesium salts of C₁₄-C₂₂fatty acids, and, optionally, preservatives.

The personal care preparation according to the invention may be in the form of a water-in-oil or oil-in-water emulsion, an alcoholic or alcohol-containing formulation, a vesicular dispersion of an ionic or non-ionic ampiphilic lipid, a gel, a solid stick or an aerosol formulation.

As a water-in-oil or oil-in-water emulsion, the cosmetically tolerable adjuvant contains preferably from 5 to 50% of an oil phase, from 5 to 20% of an emulsifier and from 30 to 90% water. The oil phase may comprise any oil suitable for cosmetic formulations, for example one or more hydrocarbon oils, a wax, a natural oil, a silicone oil, a fatty acid ester or a fatty alcohol. Preferred mono- or poly-ols are ethanol, isopropanol, propylene glycol, hexylene glycol, glycerol and sorbitol.

Cosmetic formulations according to the invention are used in various fields. There come into consideration, for example, the following preparations:
skin-care preparations, e.g. skin-washing and cleansing preparations in the form of tablet-form or liquid soaps, synthetic detergents or washing pastes,
bath preparations, e.g. liquid (foam baths, milks, shower preparations) or solid bath preparations, e.g. bath cubes and bath salts;
skin-care preparations, e.g. skin emulsions, multi-emulsions or skin oils;
cosmetic personal care preparations, e.g. facial make-up in the form of day creams or powder creams, face powder (loose or pressed), rouge or cream make-up, eye-care preparations, e.g. eye shadow preparations, mascaras, eyeliners, eye creams or eye-fix creams; lip-care preparations, e.g. lipsticks, lip gloss, lip contour pencils, nail-care preparations, such as nail varnish, nail varnish removers, nail hardeners or cuticle removers;
intimate hygiene preparations, e.g. intimate washing lotions or intimate sprays;
foot-care preparations, e.g. foot baths, foot powders, foot creams or foot balsams, special deodorants and antiperspirants or callus-removing preparations;
light-protective preparations, such as sun milks, lotions, creams or oils, sun-blocks or tropicals, pre-tanning preparations or after-sun preparations;
skin-tanning preparations, e.g. self-tanning creams;
depigmenting preparations, e.g. preparations for bleaching the skin or skin-lightening preparations;
insect-repellents, e.g. insect-repellent oils, lotions, sprays or sticks;
deodorants, such as deodorant sprays, pump-action sprays, deodorant gels, sticks or roll-ons;
antiperspirants, e.g. antiperspirant sticks, creams or roll-ons;
preparations for cleansing and caring for blemished skin, e.g. synthetic detergents (solid or liquid), peeling or scrub preparations or peeling masks;
hair-removal preparations in chemical form (depilation), e.g. hair-removing powders, liquid hair-removing preparations, cream- or paste-form hair-removing preparations, hair-removing preparations in gel form or aerosol foams;
shaving preparations, e.g. shaving soap, foaming shaving creams, non-foaming shaving creams, foams and gels, preshave preparations for dry shaving, aftershaves or aftershave lotions;
fragrance preparations, e.g. fragrances (eau de Cologne, eau de toilette, eau de parfum, parfum de toilette, perfume), perfume oils or perfume creams;
dental care, denture-care and mouth-care preparations, e.g. toothpastes, gel toothpastes, tooth powders, mouthwash concentrates, anti-plaque mouthwashes, denture cleaners or denture fixatives;
cosmetic hair-treatment preparations, e.g. hair-washing preparations in the form of shampoos and conditioners, hair-care preparations, e.g. pretreatment preparations, hair tonics, styling creams, styling gels, pomades, hair rinses, treatment packs, intensive hair treatments, hair-structuring preparations, e.g. hair-waving preparations for permanent waves (hot wave, mild wave, cold wave), hair-straightening preparations, liquid hair-setting preparations, hair foams, hairsprays, bleaching preparations, e.g. hydrogen peroxide solutions, lightening shampoos, bleaching creams, bleaching powders, bleaching pastes or oils, temporary, semi-permanent or permanent hair colorants, preparations containing self-oxidising dyes, or natural hair colorants, such as henna or camomile.

The following represent examples of various formulations containing the antimicrobial compound of the invention. Obviously, these are simple, basic formulations only and a wide variety of similar formulations are known in the art into which the present antimicrobials are readily incorporated at various concentrations.

An antimicrobial soap has, for example, the following composition:

0.01 to 5% by weight of antimicrobial compound,

0.3 to 1% by weight titanium dioxide,

1 to 10% by weight stearic acid,

soap base ad 100%, e.g. a sodium salt of tallow fatty acid or coconut fatty acid, or glycerol.

A shampoo has, for example, the following composition:

0.01 to 5% by weight of antimicrobial compound,

12.0% by weight sodium laureth-2-sulfate,

4.0% by weight cocamidopropyl betaine,

3.0% by weight NaCI and

water ad 100%.

A deodorant has, for example, the following composition:

0.01 to 5% by weight antimicrobial compound,

60% by weight ethanol,

0.3% by weight perfume oil, and

water ad 100%.

The invention relates also to an oral composition containing from 0.01 to 15% by weight, based on the total weight of the composition, of the antimicrobial compound, and orally tolerable adjuvants.

Example of an oral composition:

10% by weight sorbitol,

10% by weight glycerol,

15% by weight ethanol,

15% by weight propylene glycol,

0.5% by weight sodium lauryl sulfate,

0.25% by weight sodium methylcocyl taurate,

0.25% by weight polyoxypropylene/polyoxyethylene block copolymer,

0.10% by weight peppermint flavouring,

0.1 to 0.5% by weight of antimicrobial compound, and

48.6% by weight water.

The oral composition according to the invention may be, for example, in the form of a gel, a paste, a cream or an aqueous preparation (mouthwash).

The oral composition according to the invention may also comprise compounds that release fluoride ions which are effective against the formation of caries, for example inorganic fluoride salts, e.g. sodium, potassium, ammonium or calcium fluoride, or organic fluoride salts, e.g. amine fluorides, which are known under the trade name OLAFLUOR.

The anti-microbial compounds of this invention are also suitable for treating, especially preserving, textile fibre materials. Such materials are undyed and dyed or printed fibre materials, e.g. of silk, wool, polyamide or polyurethanes, and especially cellulosic fibre materials of all kinds. Such fibre materials are, for example, natural cellulose fibres, such as cotton, linen, jute and hemp, as well as cellulose and regenerated cellulose.

The antimicrobial compounds of this invention are suitable also for treating, especially imparting antimicrobial properties to or preserving, plastics, e.g. polyethylene, polypropylene, polyurethane, polyester, polyamide, polycarbonate, latex etc. Fields of use therefore are, for example, floor coverings, plastics coatings, plastics containers and packaging materials; kitchen and bathroom utensils (e.g. brushes, shower curtains, sponges, bathmats), latex, filter materials (air and water filters), plastics articles used in the field of medicine, e.g. dressing materials, syringes, catheters etc., so-called “medical devices”, gloves and mattresses.

The antimicrobial compounds of this invention are suitable also for treating, especially imparting antimicrobial properties to or preserving industrial formulations such as coatings, lubricants etc.

Paper, for example papers used for hygiene purposes, may also be provided with antimicrobial properties using the present anti-microbial compounds.

It is also possible for nonwovens, e.g. nappies/diapers, sanitary towels, panty liners, and cloths for hygiene and household uses, to be provided with antimicrobial properties in accordance with the invention.

The antimicrobial compounds of this invention are also used in washing and cleaning formulations, e.g. in liquid or powder washing agents or softeners.

The antimicrobial polyglycerol polymers or co-polymers can also be used in household and general-purpose cleaners for cleaning and disinfecting hard surfaces.

A cleaning preparation has, for example the following composition:

0.01 to 5% by weight antimicrobial compound

3.0% by weight octyl alcohol 4EO

1.3% by weight fatty alcohol C₈-C₁₀polyglucoside

3.0% by weight isopropanol

water ad 100%.

In addition to preserving cosmetic and household products, the preservation of technical products, the provision of technical products with antimicrobial properties and use as a biocide in technical processes are also possible, for example in paper treatment, especially in paper treatment liquors, printing thickeners of starch or cellulose derivatives, surface-coatings and paints.

The antimicrobial compounds of the invention are also suitable for the antimicrobial treatment of wood and for the antimicrobial treatment of leather, the preserving of leather and the provision of leather with antimicrobial properties.

The compounds according to the invention are also suitable for the protection of cosmetic products and household products from microbial damage.

In addition to their generally antimicrobial action, the compounds of formula (1) are capable of penetrating biofilms on living and non-living surfaces, of preventing the adhesion of bacteria to surfaces and any further build-up of the biofilm, of detaching such biofilm and/or inhibiting the further growth of the biofilm-forming micro-organisms in the biological matrix, or of killing such micro-organisms.

Biofilms are understood, very generally, to be aggregations of living and dead micro-organisms, especially bacteria, that adhere to living and non-living surfaces, together with their metabolites in the form of extracellular polymeric substances (EPS matrix), e.g. polysaccharides. The activity of antimicrobial substances that normally exhibit a pronounced growth-inhibiting or lethal action with respect to planktonic cells may be greatly reduced with respect to microorganisms that are organized in biofilms, for example because of inadequate penetration of the active substance into the biological matrix.

In the present invention, this may relate to biofilms on human tooth surfaces and oral mucosa, which play a crucial role in the onset of degenerative diseases in the oral cavity, e.g. caries or periodontitis, as a result of the biofilm-forming micro-organisms or their metabolites.

Action against bio-films in the present invention also relates to biofilms on non-human surfaces. Co-pending application Ser. No. 11/524,980, which is hereby incorporated in its entirety by reference, discloses compounds useful in coatings or films in protecting surfaces from bio-fouling. Such surfaces include surfaces in contact with marine environments (including fresh water, brackish water and salt water environments), for example, the hulls of ships, surfaces of docks or the inside of pipes in circulating or pass-through water systems. Other surfaces are susceptible to similar biofouling, for example walls exposed to rain water, walls of showers, roofs, gutters, pool areas, saunas, floors and walls exposed to damp environs such as basements or garages and even the housing of tools and outdoor furniture.

The antimicrobial compounds of this invention are useful in preventing bio-fouling, or eliminating or controlling microbe accumulation on the surfaces described in co-pending application Ser. No. 11/524,980 either by incorporating the antimicrobial compounds into the article or surface of the article in question or by applying the antimicrobial to these surfaces as part of a coating or film as described in co-pending application Ser. No. 11/524,980.

When applied as a part of a film or coating, the antimicrobial compounds of this invention are part of a composition which also comprises a binder.

The binder may be any polymer or oligomer compatible with the present antimicrobials. The binder may be in the form of a polymer or oligomer prior to preparation of the anti-fouling composition, or may form by polymerization during or after preparation, including after application to the substrate. In certain applications, such as certain coating applications, it will be desirable to crosslink the oligomer or polymer of the anti fouling composition after application.

The term binder as used in the present invention also includes materials such as glycols, oils, waxes and surfactants commercially used in the care of wood, plastic, glass and other surfaces. Examples include water proofing materials for wood, vinyl protectants, protective waxes and the like.

The composition may be a coating or a film. When the composition is a thermoplastic film which is applied to a surface, for example, by the use of an adhesive or by melt applications including calendaring and co-extrusion, the binder is the thermoplastic polymer matrix used to prepare the film.

When the composition is a coating, it may be applied as a liquid solution or suspension, a paste, gel, oil or the coating composition may be a solid, for example a powder coating which is subsequently cured by heat, UV light or other method.

As the composition of the invention may be a coating or a film, the binder can be comprised of any polymer used in coating formulations or film preparation. For example, the binder is a thermoset, thermoplastic, elastomeric, inherently crosslinked or crosslinked polymer.

Thermoset, thermoplastic, elastomeric, inherently crosslinked or crosslinked polymers include polyolefin, polyamide, polyurethane, polyacrylate, polyacrylamide, polycarbonate, polystyrene, polyvinyl acetates, polyvinyl alcohols, polyester, halogenated vinyl polymers such as PVC, natural and synthetic rubbers, alkyd resins, epoxy resins, unsaturated polyesters, unsaturated polyamides, polyimides, silicon containing and carbamate polymers, fluorinated polymers, crosslinkable acrylic resins derived from substituted acrylic esters, e.g. from epoxy acrylates, urethane acrylates or polyester acrylates. The polymers may also be blends and copolymers of the preceding chemistries.

Biocompatible coating polymers, such as, poly[-alkoxyalkanoate-co-3-hydroxyalkenoate] (PHAE) polyesters, Geiger et. al. Polymer Bulletin 52, 65-70 (2004), can also serve as binders in the present invention.

Alkyd resins, polyesters, polyurethanes, epoxy resins, silicone containing polymers, polyacrylates, polyacrylamides, fluorinated polymers and polymers of vinyl acetate, vinyl alcohol and vinyl amine are non-limiting examples of common coating binders useful in the present invention. Other coating binders, of course, are part of the present invention.

Coatings are frequently crosslinked with, for example, melamine resins, urea resins, isocyanates, isocyanurates, polyisocyanates, epoxy resins, anhydrides, poly acids and amines, with or without accelerators.

The compositions of present invention are for example a coating applied to a surface which is exposed to conditions favorable for bioaccumulation. The presence of the antimicrobial compounds of this invention in said coating will prevent the adherence of organisms to the surface.

The anti-microbial compounds of the present invention may be part of a complete coating or paint formulation, such as a marine gel-coat, shellac, varnish, lacquer or paint, or the anti fouling composition may comprise only a polymer of the instant invention and binder, or a polymer of the instant invention, binder and a carrier substance. It is anticipated that other additives encountered in such coating formulations or applications will find optional use in the present applications as well.

The coating may be solvent borne or aqueous. Aqueous coatings are typically considered more environmentally friendly.

The coating is, for example, aqueous dispersion of a polymer of the instant invention and a binder or a water based coating or paint. For example, the coating comprises an aqueous dispersion of a polymer of the instant invention and an acrylic, methacrylic or acrylamide polymers or co-polymers or a poly[-alkoxyalkanoate-co-3-hydroxyalkenoate]polyester.

The coating may be applied to a surface which has already been coated, such as a protective coating, a clear coat or a protective wax applied over a previously coated article.

Coating systems include marine coatings, wood coatings, other coatings for metals and coatings over plastics and ceramics. Exemplary of marine coatings are gel coats comprising an unsaturated polyester, a styrene and a catalyst.

The coating is, for example a house paint, or other decorative or protective paint. It may be a paint or other coating that is applied to cement, concrete or other masonry article. The coating may be a water proofer as for a basement or foundation.

The coating composition is applied to a surface by any conventional means including spin coating, dip coating, spray coating, draw down, or by brush, roller or other applicator. A drying or curing period will typically be needed.

Coating or film thickness will vary depending on application and will become apparent to one skilled in the art after limited testing.

The composition may be in the form of a protective laminate film.

Such a film typically comprises thermoset, thermoplastic, elastomeric, or crosslinked polymers. Examples of such polymers include, but are not limited to, polyolefin, polyamide, polyurethane, polyacrylate, polyacrylamide, polycarbonate, polystyrene, polyvinyl acetates, polyvinyl alcohols, polyester, halogenated vinyl polymers such as PVC, natural and synthetic rubbers, alkyd resins, epoxy resins, unsaturated polyesters, unsaturated polyamides, polyimides, fluorinated polymers, silicon containing and carbamate polymers. The polymers may also be blends and copolymers of the preceding chemistries.

When the anti-fouling composition is a preformed film it is applied to the surface by, for example, the use of an adhesive, or co-extruded onto the surface. It may also be mechanically affixed via fasteners which may require the use of a sealant or caulk wherein the esters of the instant invention may also be advantageously employed.

A plastic film may also be applied with heat which includes calendaring, melt applications and shrink wrapping.

The composition may be part of a polish, such a furniture polish, or a dispersant or surfactant formulation such as a glycol or mineral oil dispersion or other formulation as used in for example wood protection.

Examples of useful surfactants include, but are not limited to, polyoxyethylene-based surface-active substances, including polyoxyethylene sorbitan tetraoleate (PST), polyoxyethylene sorbitol hexaoleate (PSH), polyoxyethylene 6 tridecyl ether, polyoxyethylene 12 tridecyl ether, polyoxyethylene 18 tridecyl ether, TWEEN® surfactants, TRITON® surfactants, and the polyoxyethlene-polyoxypropylene copolymers such as the PLURONIC® and POLOXAMER® product series (from BASF). Other matrix-forming components include dextrans, linear PEG molecules (MW 500 to 5,000,000), star-shaped PEG molecules, comb-shaped and dendrimeric, hyperbrached PEG molecules, as well as the analogous linear, star, and dendrimer polyamine polymers, and various carbonated, perfluorinated (e.g., DUPONT ZONYL® fluorosurfactants) and siliconated (e.g., dimethylsiloxane-ethylene oxide block copolymers) surfactants.

Given the wide array of applications for the present anti-microbial compositions, the composition may contain other additives such as antioxidants, UV absorbers, hindered amines, phosphites or phosphonites, benzofuran-2-ones, thiosynergists, polyamide stabilizers, metal stearates, nucleating agents, fillers, reinforcing agents, lubricants, emulsifiers, dyes, pigments, dispersants, other optical brighteners, flame retardants, antistatic agents, blowing agents and the like, such as the materials listed below, or mixtures thereof.

The substrate can be an inorganic or organic substrate, for example, a metal or metal alloy; a thermoplastic, elastomeric, inherently crosslinked or crosslinked polymer as described above; a natural polymer such as wood or rubber; a ceramic material; glass; leather or other textile.

The substrate may be, for example, non-metal inorganic surfaces such as silica, silicon dioxide, titanium oxides, aluminum oxides, iron oxides, carbon, silicon, various silicates and sol-gels, masonry, and composite materials such as fiberglass and plastic lumber (a blend of polymers and wood shavings, wood flour or other wood particles).

The inorganic or organic substrate is, for example, a metal or metal alloy, a thermoplastic, elastomeric, inherently crosslinked or crosslinked polymer, a ceramic material or a glass.

The substrate may be a multi-layered article comprised of the same or different components in each layer. The surface coated or laminated may be the exposed surface of an already applied coating or laminate.

The inorganic or organic substrate to be coated or laminated can be in any solid form.

For example, polymer substrates may be plastics in the form of films, injection-molded articles, extruded workpieces, fibres, felts or woven fabrics.

For example molded or extruded polymeric articles used in construction or the manufacture of durable goods such as siding, fascia and mailboxes can all benefit from the present method for stabilizer replenishment.

Plastics which would benefit from the present method include, but are not limited to, plastics used in construction or the manufacture of durable goods or machine parts, including outdoor furniture, boats, siding, roofing, glazing, protective films, decals, sealants, composites like plastic lumber and fiber reinforced composites, functional films including films used in displays as well as articles constructed from synthetic fibers such as awnings, fabrics such as used in canvas or sails and rubber articles such as outdoor matting and other uses cited in this disclosure. Exemplary of such plastics are polypropylene, polyethylene, PVC, POM, polysulfones, styrenics, polyamides, urethanes, polyesters, polycarbonate, acrylics, butadiene, thermoplastic polyolefins, ionomers, unsaturated polyesters and blends of polymer resins including ABS, SAN and PC/ABS.

The anti-microbial compounds of the invention are also effective in protecting useful plants, such as plants in agriculture, in horticulture and in forests, plant parts and seeds from disease and spoilage. For example, the present invention also provides a method which comprises applying to useful plants, the locus thereof or propagation material thereof a composition which comprises at least one of the polyglycerol polymers and co-polymers of the invention. Said compositions can be used as foliar, soil and seed treatment fungicides.

The compositions of the invention it is possible to inhibit or destroy the phytopathogenic microorganisms which occur in plants or in parts of plants (fruit, blossoms, leaves, stems, tubers, roots) in different useful plants. The present compositions are applied by treating the fungi, the useful plants, the locus thereof, the propagation material thereof, the natural substances of plant origin, which have been taken from the natural life cycle, and/or their processed forms, or the industrial materials threatened by fungus attack with the compositions in an effective amount.

The compositions according to the invention may be applied before or after infection of the useful plants, the propagation material thereof, the natural substances of plant and/or animal origin, which have been taken from the natural life cycle, and/or their processed forms, or the industrial materials by the fungi.

The compositions of the present invention are of particular interest for controlling a large number of fungi in various useful plants or their seeds, especially in field crops such as potatoes, tobacco and sugarbeets, and wheat, rye, barley, oats, rice, maize, lawns, cotton, soybeans, oil seed rape, pulse crops, sunflower, coffee, sugarcane, fruit and ornamentals in horticulture and viticulture, in vegetables such as cucumbers, beans and cucurbits.

When applied to plants, the anti-microbial compounds of the invention are applied at a rate of 1 to 5000 g a.i./ha, for example 2 to 2000 g a.i./ha, for example, 5 to 2000 g a.i./ha, for example, 10 to 1000 g a.i./ha, e.g. 50, 75, 100, 200, 250, 500, 800, 1000, 1500 g a.i./ha of polymer or co-polymers.

In agricultural practice the application rates depend on the type of effect desired, and typically range from 20 to 4000 g of total antimicrobials per hectare.

When treating seed, rates of 0.001 to 50 g of the present anti-microbial compounds, for example 0.01 to 10 g, per kg of seed, are generally sufficient.

The composition comprising the anti-microbial compounds of the invention may be employed in any conventional form, for example in the form a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects). For example, formulations to be applied in spraying forms, such as water dispersible concentrates (e.g. EC, SC, DC, OD, SE, EW, EO and the like), wettable powders and granules, typically contain surfactants such as wetting and dispersing agents and other compounds that provide adjuvancy effects.

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of at least one of the anti-microbial compounds, from 0 to 20% agriculturally acceptable surfactant and 10 to 99.99% solid or liquid formulation inerts and adjuvant(s), and optionally other active agents, particularly microbiocides or conservatives or the like. Concentrated forms of compositions generally contain in between about 2 and 80%, for example, between about 5 and 70% by weight of total active agent. Application forms of formulation may for example contain from 0.01 to 20% by weight, for example from 0.01 to 5% by weight of active agent.

Methods of preparing the above plant protection formulations are well known, for example, in US Published Pat. Appl. 20070265267, already incorporated by reference.

Particular embodiments of the invention therefore relate to

methods for protecting plastics, coatings, other materials of construction, home or personal care formulations, plants, agricultural products, industrial formulations or technical process against the action of microbes which comprises adding an effective amount of the anti-microbial compounds of the present invention;

a method for protecting skin, mucosa and integumentary appendages against the action of microbes including protecting the scalp from dandruff, which comprises applying a preparation comprising an effective amount of the anti-microbial compounds of the present invention;

a method for protecting paper, wood, leather, synthetic textile materials or natural textile materials such as cotton against the action of microbes comprising incorporating or applying an effective amount of the present polymer or copolymer or a composition comprising an effective amount the anti-microbial compounds of the present invention;

a method for cleaning and disinfecting hard surfaces which comprises applying a preparation comprising an effective amount of the anti-microbial compounds of the present invention;

a method for preventing bio-fouling of an article comprising incorporating anti-microbial compounds of the present invention into the article or surface of the article or by applying the anti-microbial compounds of the present invention to these surfaces either directly or as part of a coating or film.

Other materials of construction include, in addition to wood, metals, paper, glass, ceramics, coatings, plastics and textiles, materials such as concrete, cement, adhesives, caulking materials, composites of natural and synthetic materials etc.

While some of the anti-microbial agents of the inventive compositions are known compounds, many are novel. The novel compounds are prepared using the above described reactions and standard derivation reactions of alcohols. For example, novel compounds include compounds of formula Id, II, III, or IV

wherein each R is independently C₁₋₂₄ alkyl or C₁₋₂₄ alkylcarbonyl which is interrupted one or more times by —O—, —N(R″)— or —CON(R″)—, and/or substituted by one or more —NR″R″, halogen, ammonium salt, —COOM, -L-Ar,

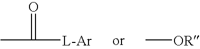

wherein each R′ and R″ are independently H, C₁₋₂₄ alkyl, C₃₋₂₄ alkenyl or C₁₋₂₄ alkylcarbonyl which are uninterrupted or interrupted one or more times by one or more oxygen atoms, carbonyl, —COO—, —CON H—, —NH—, —CON(C₁₋₂₄ alkyl)- or —N(C₁₋₂₄ alkyl)-, which uninterrupted or interrupted alkyl, alkenyl, or alkylcarbonyl are unsubstituted or substituted one or more times by one or more groups selected from halogen, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, —SO₃M, phenyl, phenyl substituted one or more times by one or more C₁₋₈ alkyl, naphthyl, naphthyl substituted one or more times by one or more C₁₋₈ alkyl, ammonium salt, phosphonic acid, phosphonate salt,

or when two R″ are attached to a nitrogen atom they may form, together with the nitrogen atom to which they are attached, form a 5-, 6- or 7-membered ring which is uninterrupted or interrupted by —O—, —NH— or —N(C₁₋₁₂ alkyl)-;

or R″ is a group -L-Ar,

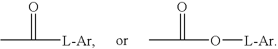

For example compounds of formulae Id, II, III, IV or IVa, wherein R and R′ are selected from C₁₋₂₄ alkyl and C₁₋₂₄ alkylcarbonyl which are interrupted one or more times by —N(H)— or —N(R″)—, and/or substituted by one or more —NH₂, —NHR″, —NR″R″, halogen, ammonium salt, —COOM, —OH or —OR″,

each R″ are independently C₁₋₂₄ alkyl or C₁₋₂₄ alkylcarbonyl which alkyl or alkylcarbonyl are uninterrupted or interrupted one or more times by one or more —O—, —NH— or —N(C₁₋₂₄ alkyl)-, and which uninterrupted or interrupted alkyl or alkylcarbonyl are unsubstituted or substituted one or more times by one or more groups selected from halogen, ammonium salt, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, phenyl, phenyl substituted one or more times by one or more C₁₋₈ alkyl, naphthyl and naphthyl substituted one or more times by one or more C₁₋₈ alkyl;

or, for example, R″ is hydrogen, C₁₋₂₄ alkyl or C₁₋₂₄ alkylcarbonyl, which alkyl or alkylcarbonyl are uninterrupted or interrupted one or more times by —O—, —NH— or —N(C₁₋₂₄ alkyl)-, and/or substituted one or more times by one or more groups selected from halogen, ammonium salt, —OH, C₁₋₂₄alkoxy, C₂₋₂₄alkylcarbonyl, —NH₂, —N(H)(C₁₋₂₄alkyl) or —N(C₁₋₂₄ alkyl)₂.

### EXAMPLES

The following non-limiting examples illustrate some aspects of the invention.

General Acylation Procedure

To a solution of the polyol in DMF cooled with an external ice/brine bath is added triethylamine followed by dropwise addition of acid halide after which the reaction is heated at 60° C. for 48 hours. A suitable extraction solvent is added and the mixture is washed with water and brine, dried over sodium or magnesium sulfate filtered and concentrated to give the ester derivative.

### Example 1

Following the above general procedure, trimethylol propane is reacted with 6-bromohexanoyl chloride to yield the following compound:

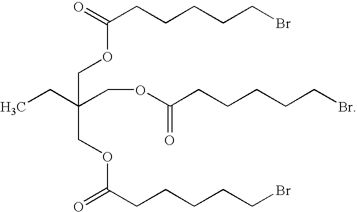

### Example 2

Following the procedure of Example 1, trimethylol propane is reacted with chloroacetyl chloride to yield

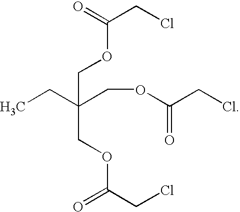

### Example 3

Following the procedure of Example 1, trimethylol propane is reacted with 3-bromo proprionylchloride to yield

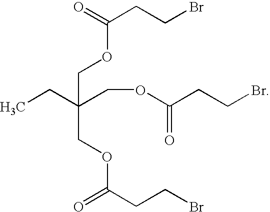

### Example 4

Following the procedure of Example 1, trimethylol propane is reacted with 4-bromo butyroylylchloride to yield

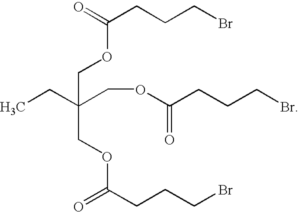

### Example 5

Following the procedure of Example 1, trimethylol propane is reacted with 11-bromo undecanoylchloride to yield

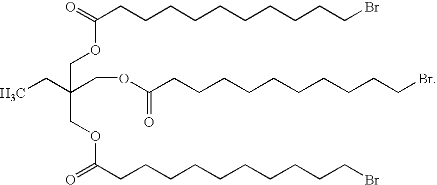

### Example 6

Following the procedure of Example 1, trimethylol propane is reacted with acryloyl chloride to yield

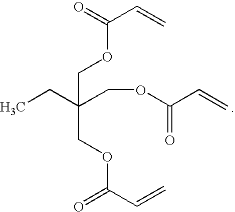

Following the above procedure, pentaerythritol and di-petaerythritol are each reacted in separate experiments with 6-bromohexanoyl chloride, 1-chloroacetyl chloride, and acryloyl chloride to generate the following compounds:

| 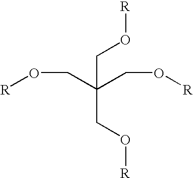 | | 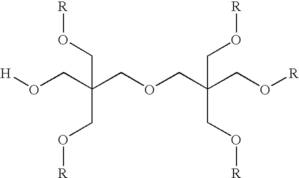 | |
|---|---|---|---|
| Ex. | R | Ex. | R |
| 7 | 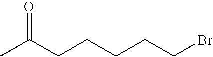 | 10 | 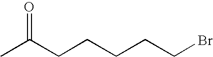 |
| 8 | 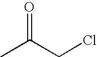 | 11 | 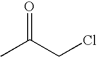 |
| 9 | 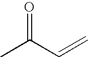 | 12 | 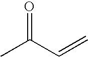 |

### Example 13-15

Following the procedure of Example 1, di-petaerythritol propane is reacted separately with 3-bromo proprionylchloride, 4-bromo butyroylylchloride and 11-bromo undecanoylchloride to yield

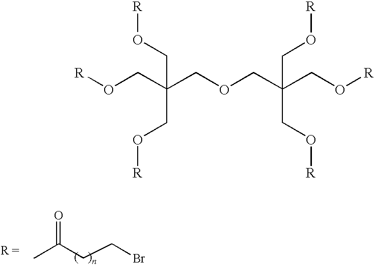

Example 13, n=1

Example 14, n=2

Example 15, n=11,

which compounds are readily derivatized following the following procedures.

### Example 16

To the compound produced in Example 1 is added dodecylamine and potassium hydroxide in ethanol and the mixture is stirred for 22 hours at 80° C., allowed to cool then filtered through Celite and concentrated to yield

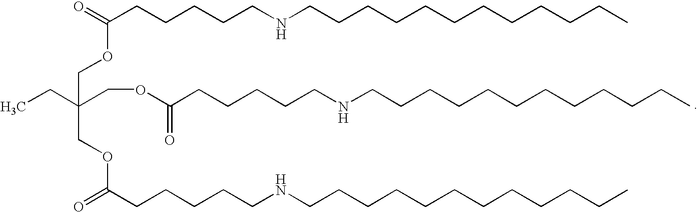

### Example 17

Following the procedure of Example 17, to the compound produced in Example 1 is added N,N-di-dodecylamine and potassium hydroxide in ethanol to yield

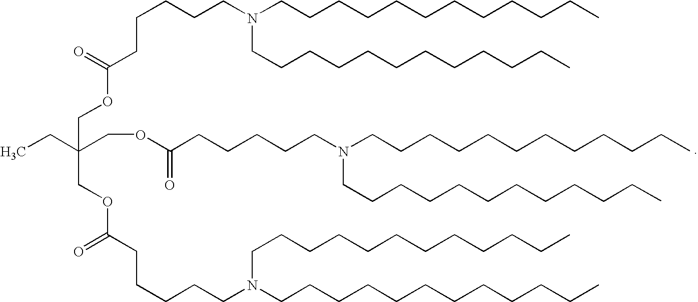

### Example 18

To the compound produced in Example 3 is added octylamine in chloroform and the mixture stirred at room temperature for 48 hours. The reaction mixture is concentrated, taken up in ethyl acetate, washed with water, dried over sodium sulfate, filtered and concentrated to yield a solid of the formula

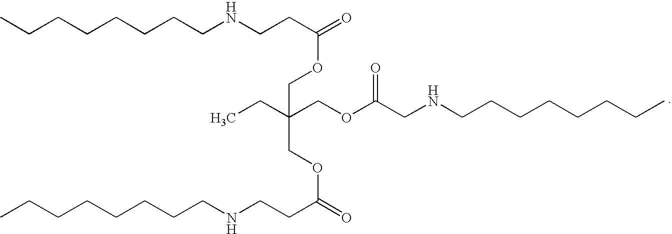

### Example 19

Following the procedure of Example 18, to the compound produced in Example 3 is added dodecylamine to yield a solid of the formula

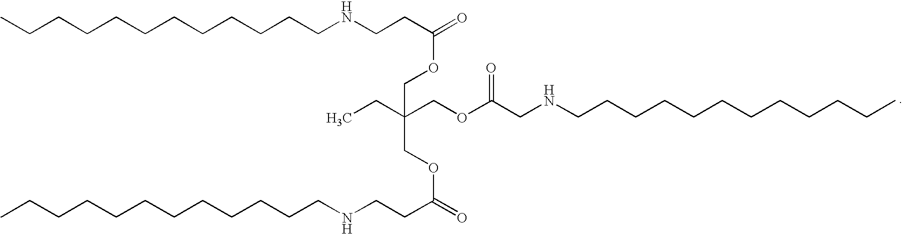

Following the procedure of example 18, the compounds produced in Examples 9 and 12 are each reacted in separate experiments with octylamine and dodecylamine to produce the following compounds:

| 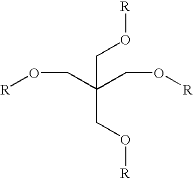 | | 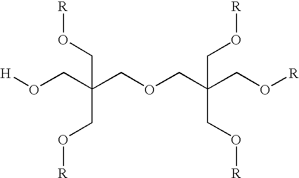 | |
|---|---|---|---|
| Ex. | R | Ex. | R |
| 20 | 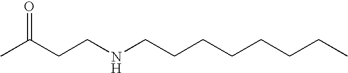 | 22 | 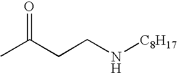 |
| 21 | 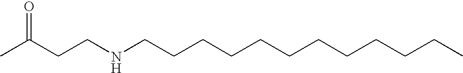 | 23 | 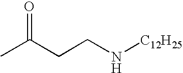 |

### Example 24

Following the procedure of Example 18, octyl amine is added to the commercially available tris-acrylate:

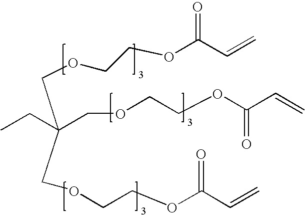

to yield a compound of the formula:

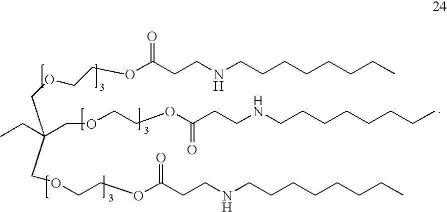

Microbiological Activity:

The compounds from examples 12-17 are tested for activity against bacteria, e. coli, s. aureus; fungi, a. pull, p. funic, a. niger, adhesion of microbes or biofilm accumulation. All compounds are effective in at least one test; some are effective in more than one test. The log reduction, or alternatively the percent reduction, in microbe populations provided by the antimicrobial composition correlates to antibacterial activity. A log reduction of 3-5 is most preferred, a 1-3 reduction is preferred, whereas a log reduction of less than 1 is least preferred, for a particular contact time.

Microbicidal activity is tested according to trivial modifications of the standard EN1040 test method. A bacterial suspension with a cell count of about 10⁷ cfu/ml is contacted with appropriate concentrations of the specific substances and the residual cell count is determined after incubation times of 5 and 30 min. at room temperature under continuous stirring. Staphylococcus aureus is tested as gram+ and Escherichia coli as gram-organism. The resulting cell count reduction is compared to a water control.

Fungicidal activity is tested according to trivial modifications of the standard EN12175 test method. A fungal spore suspension with a spore cell count of about 10⁶ cfu/ml is contacted with appropriate concentrations of the specific substances and the residual spore cell count is determined after incubation times of 30 and 60 min. and 24 hours at room temperature under continuous stirring. Penicillium funiculosum, Aspergillus niger and Aureobasidium pullulans are tested as important mold strains. The resulting cell count reduction is compared to a water control.

Biofilm inhibition is tested in a microplate based screening assay. Standard test specimen of polycarbonate are contacted with compound solutions in water or ethanol at a concentration of 0.5% for ½ hour for the compounds to form a film on the pin surface. The pins are then dried at room temperature under laminar flow. The coated pins are contacted with a bacterial inoculum of Staphylococcus aureus at a cell count of 10⁴-10⁵ cfu/ml in a microplate and a biofilm is allowed to form on the plastic surface over 24 hours. Loosely attached cells are then rinsed off in a couple of rinsing steps, then the biofilm on the surface is removed by ultrasonic treatment. The eluted cells are transferred into new microplates in Caso broth and growth is followed by measurement of optical density at 620 nm over 24 hours. The results are evaluated as growth curves of the eluted cells over 24 hours incubation time in comparison to the growth curve of untreated samples.

Following the above procedures the antifungal activity of the compounds from examples 18, 16, 20, 21, 22 and 23 at 1% concentrations are tested against Penicillium funiculosum, Aspergillus niger and Aureobasidium pullulans. The results are listed below:

| | P. funic. | | | |
|---|---|---|---|---|
| | cfu/mL | log reduction | | |
| | 3.60E+07 | 30 min | 1 h | 24 h |
| Ex 18 | <10 | >4 | >4 | >4 |
| Ex 16 | <10 | >4 | >4 | >4 |
| Ex 20 | <10 | >4 | >4 | >4 |
| Ex 21 | <10 | >4 | >4 | >4 |
| Ex 22 | <10 | >4 | >4 | >4 |
| Ex 23 | <10 | >4 | >4 | >4 |

| | A. niger | | | |
|---|---|---|---|---|
| | cfu/mL | log reduction | | |
| | 2.60E+08 | 30 min | 1 h | 24 h |
| Ex 18 | <10 | >4 | >4 | >4 |
| Ex 16 | <10 | >4 | >4 | >4 |
| Ex 20 | <10 | >4 | >4 | >4 |
| Ex 21 | <10 | >4 | >4 | >4 |
| Ex 22 | <10 | >4 | >4 | >4 |
| Ex 23 | <10 | >4 | >4 | >4 |

| | A. pull. | | | |
|---|---|---|---|---|
| | cfu/mL | log reduction | | |
| | 4.0E+06 | 30 min | 1 h | 24 h |
| Ex 18 | <10 | >4 | >4 | >4 |
| Ex 16 | <10 | >4 | >4 | >4 |
| Ex 20 | <10 | >4 | >4 | >4 |
| Ex 21 | <10 | >4 | >4 | >4 |
| Ex 22 | <10 | >4 | >4 | >4 |
| Ex 23 | <10 | >4 | >4 | >4 |

The Microbicidal activity of the compound from example 24,

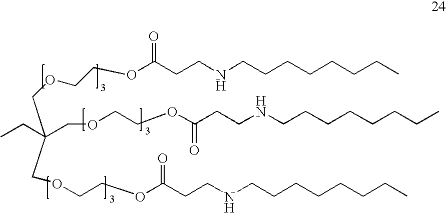

is determined according to trivial modifications of the standard EN1040 test method for M. furfur. A bacterial suspension with a cell count of about 10⁶ cfu/ml is contacted with the compound from example 24 at the concentration shown below and the residual cell count is determined after incubation times of 1, 5 and 30 min. at room temperature under continuous stirring. The resulting cell count reduction is compared to a water control and shown in the table below.

| | M. furfur | log reduction | | |
|---|---|---|---|---|
| Sample | cfu/mL | 1 min. | 5 min. | 30 min. |
| Inoculum | 1.10E+06 | | | |
| H2O reference 5′/30′ | 2.10E+05 | <1 | <1 | <1 |
| TE2101-68 1% | <100 | >3 | >3 | >3 |

We claim:

1. An anti-microbial composition comprising as an antimicrobial agent one or more compounds of formula I 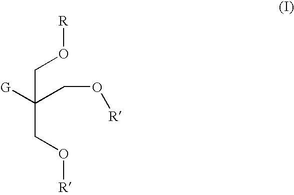
wherein G is H or C₁₋₁₂alkyl, or a group CH2-OR′,
wherein each R′ is independently H or a group R and each R is independently a substituted or unsubstituted alkyl, alkenyl, alkyl carbonyl or alkenyl carbonyl, which are incorporated into a home or personal care formulation, plant protection formulation, a natural or synthetic polymer, a coating or other material of construction.

2. An anti-microbial composition according to claim 1, wherein
G is H, C₁₋₁₂ alkyl, or a group CH2-OR′,
each R′ is independently H or a group R, and
each R is independently selected from C₁₋₂₄ alkyl, C₃₋₂₄ alkenyl, C₁₋₂₄ alkylcarbonyl and C₃₋₂₄ alkenylcarbonyl which are uninterrupted or interrupted one or more times by one or more —O—, —N(R″)—, —CON(R″)—, and are unsubstituted or substituted one or more times by one or more C₃₋₆ cycloalkyl, —OR″, —COOR″, —COOM, —SO₃M, —SO₃H, phosphonic acid, halogen, —CONR″R″, —NR″R″, phosphonate salt, ammonium salt, group of the formulae 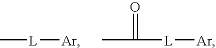
or group —Si(Y)₃ wherein each Y is independently hydroxyl, C₁₋₄ alkyl or C₁₋₄ alkoxy;
wherein each R″, independently of any other R″ is H, C₁₋₂₄ alkyl, C₃₋₂₄ alkenyl, C₃₋₆ cycloalkyl or C₁₋₂₄ alkylcarbonyl which are uninterrupted or interrupted one or more times by one or more oxygen atoms, carbonyl, —COO—, —CONH—, —NH—,—CON(C₁₋₂₄ alkyl)- or —N(C₁₋₂₄ alkyl)-,
which uninterrupted or interrupted alkyl, alkenyl, cycloalkyl or alkylcarbonyl are unsubstituted or substituted one or more times by one or more groups selected from halogen, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, —SO₃M, phenyl, phenyl substituted one or more times by one or more C₁₋₈ alkyl, naphthyl, naphthyl substituted one or more times by one or more C₁₋₈ alkyl, ammonium salt, phosphonic acid, phosphonate salt
or
when two R″ are attached to a nitrogen atom they may form, together with the nitrogen atom to which they are attached, form a 5-, 6- or 7-membered ring which is uninterrupted or interrupted by —O—, —NH— or —N(C₁₋₁₂ alkyl)-;
or R″ is a group -L-Ar, 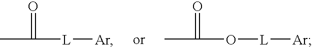
L is a direct bond, C₁₋₁₂ alkylene which is uninterrupted or interrupted by one or more oxygen atoms, —NH—, —N(C₁₋₁₂ alkyl) or phenylene, and/or unsubstituted or substituted one or more times by one or more —OH, C₁₋₈ alkyl, C₁₋₂₄ alkoxy, C₂₋₂₄alkylcarboxy, —NH₂, —N(H)(C₁₋₈ alkyl), —N(C₁₋₈ alkyl)₂ or ammonium salt:
Ar is C₆₋₁₀ aromatic or C₁₋₉ saturated or unsaturated heterocycle which C₆₋₁₀ aromatic or C₁₋₉ saturated are unsubstituted or substituted one or more times by one or more halogen, —OH, C₁₋₂₄ alkoxy, C₂₋₂₄ alkylcarboxy, —COOQ, —CONH₂, —CON(H)(C₁₋₈ alkyl), —CON(C₁₋₈ alkyl)₂, —NH₂, —N(H)(C₁₋₈ alkyl), —N(C₁₋₈ alkyl)₂, —SO₃M, SO₃M, ammonium salt, phosphonic acid, phosphonate salt, C₁₋₂₄ alkyl, C₁₋₂₄ alkyl substituted one or more times by one or more halogen, wherein Q is hydrogen, C₁₋₂₄ alkyl, metal cation, ammonium salt, glycol ether, phenyl or benzyl, or phenyl or benzyl substituted one or more times by one or more halogen, hydroxy, C₁₋₂₄ alkoxy or C₁₋₁₂ alkyl; and
M is a metal cation or an ammonium cation.

3. An anti-microbial composition according to claim 2, wherein the composition comprises as an anti-microbial agent one or more compounds selected from the formulae Id, II, III and IV: 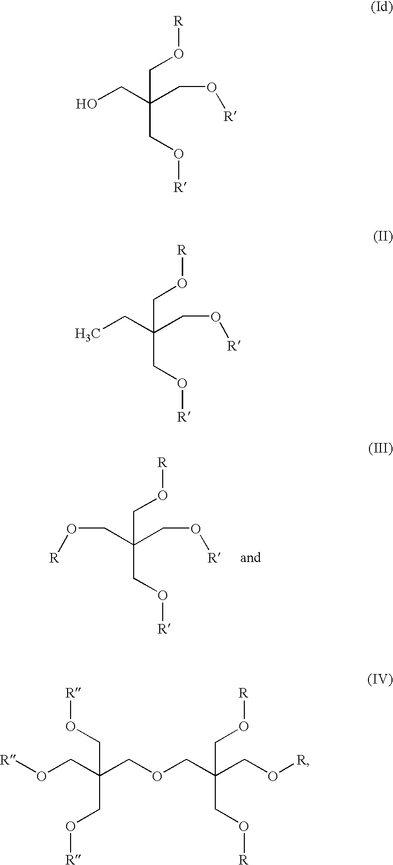
wherein each R is independently C₁₋₂₄ alkyl or C₁₋₂₄ alkylcarbonyl which is uninterrupted or interrupted one or more times by —O—, —N(R″)— or —CON(R″)—, and unsubstituted or substituted by one or more —NR″R″, halogen, ammonium salt, —COOM, -L-Ar, 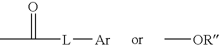
wherein each R″, independently of any other R″ is H, C₁₋₂₄ alkyl, C₃₋₂₄ alkenyl or C₁₋₂₄ alkylcarbonyl which are uninterrupted or interrupted one or more times by one or more oxygen atoms, carbonyl, —COO—, —CON H—, —NH—, —CON(C₁₋₂₄ alkyl)- or —N(C₁₋₂₄ alkyl)-, which uninterrupted or interrupted alkyl, alkenyl, or alkylcarbonyl are unsubstituted or substituted one or more times by one or more groups selected from halogen, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, —SO₃M, phenyl, phenyl substituted one or more times by one or more C₁₋₈ alkyl, naphthyl, naphthyl substituted one or more times by one or more C₁₋₈ alkyl, ammonium salt, phosphonic acid, phosphonate salt,
or when two R″ are attached to a nitrogen atom they may form, together with the nitrogen atom to which they are attached, form a 5-, 6- or 7-membered ring which is uninterrupted or interrupted by —O—, —NH— or —N(C₁₋₁₂ alkyl)-; or R″ is a group -L-Ar,

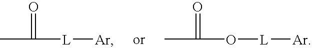

4. An anti-microbial composition according to claim 3 wherein at least one R′ and/or R″ is a group other than H.

5. An anti-microbial composition according to claim 3, wherein R is selected from C₁₋₂₄ alkyl and C₁₋₂₄ alkylcarbonyl which are uninterrupted or interrupted one or more times by —N(H)— or —N(R″)—, and/or substituted by one or more —NH₂, —NHR″, —NR″R″, halogen, ammonium salt, —COOM, —OH or —OR″,
wherein R″ is hydrogen, C₁₋₂₄ alkyl or C₁₋₂₄ alkylcarbonyl which alkyl or alkylcarbonyl are uninterrupted or interrupted one or more times by one or more —O—, —NH— or —N(C₁₋₂₄ alkyl)-, and which uninterrupted or interrupted alkyl or alkylcarbonyl are unsubstituted or substituted one or more times by one or more groups selected from halogen, ammonium salt, —OH, C₂₋₂₄alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, phenyl, phenyl substituted one or more times by one or more C₁₋₈ alkyl, naphthyl and naphthyl substituted one or more times by one or more C₁₋₈ alkyl.

6. An anti-microbial composition according to claim 5, wherein R″ is hydrogen, C₁₋₂₄ alkyl or C₁₋₂₄ alkylcarbonyl, which alkyl or alkylcarbonyl are uninterrupted or interrupted one or more times by —O—, —NH— or —N(C₁₋₂₄ alkyl)-, and/or substituted one or more times by one or more groups selected from halogen, ammonium salt, —OH, C₁₋₂₄alkoxy, C₂₋₂₄ alkylcarbonyl, —NH₂, —N(H)(C₁₋₂₄ alkyl) or —N(C₁₋₂₄ alkyl)₂.

7. An anti-microbial composition according to claim 5, wherein R is selected from C₁₋₂₄ alkylcarbonyl interrupted by —NH— or —NR″—, and/or substituted one or more times by one or more —NH₂ or NHR″—NR″R″, wherein each R″ is independently C₁₋₂₄ alkyl or C₁₋₂₄ alkylcarbonyl.

8. An anti-microbial composition according to claim 2, wherein the compounds of formula I are compounds of the formulae: 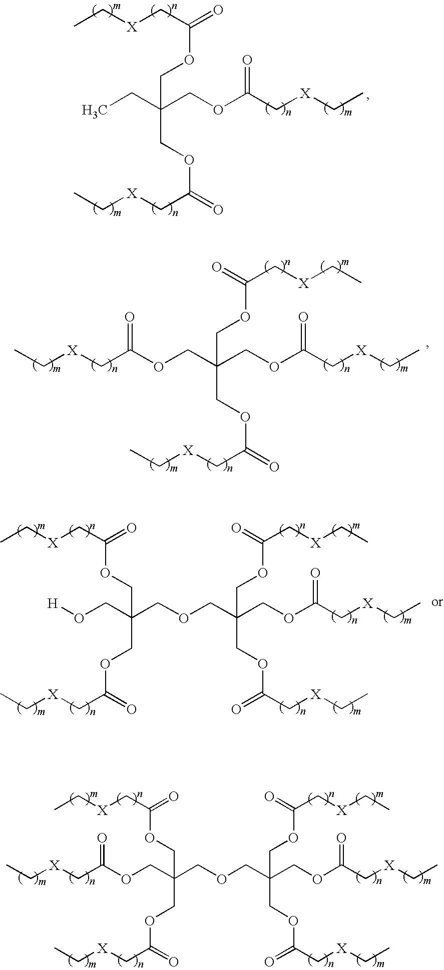
wherein each m is independently a number from 0 to 23, each n is independently a number from 1 to 23, for example, a number from 1 to 6, and X is —O—, —COO—, —NH—, —N(C₁₋₂₄ alkyl)-, —CONH— or —CON(C₁₋₂₄ alkyl)-, for example X is —NH— or —N(C₁₋₂₄ alkyl)-.

9. An anti-microbial composition according to claim 8, wherein the compounds of formula I, III or IV are compounds of the formulae:

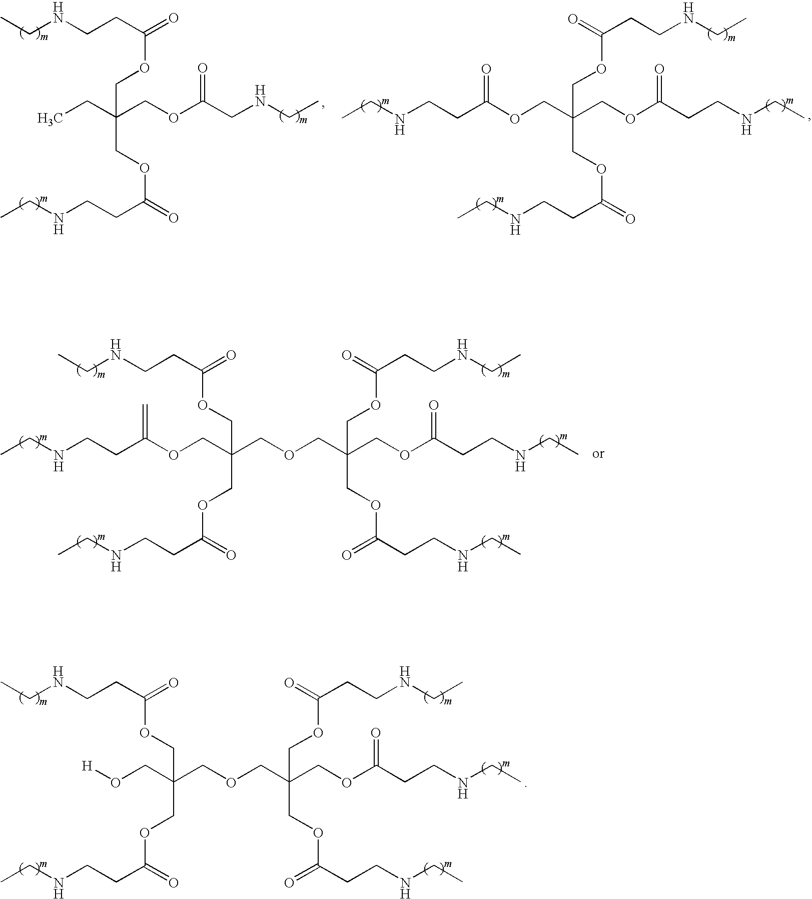

10. An anti-microbial composition according to claim 2, wherein the compound of formula I is a compound of the formula: 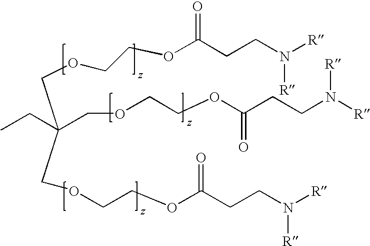
wherein z is 0, 1, 2 or 3 and each R″ is independently H or C₁₋₂₄ alkyl.

11. A method for protecting plastics, coatings, other materials of construction, home or personal care formulations, industrial formulations, or technical process against the action of microbes which comprises adding an effective amount of a compound of formula I according to claim 2 to the plastic composition, coating composition or home or personal formulation.

12. A method for protecting skin, mucosa, integumentary appendages and plants against the action of microbes which comprises applying a composition according to claim 1.

13. A method for protecting paper, wood, leather or textile materials against the action of microbes comprising incorporating into or applying onto the material an effective amount of a compound of formula I according to claim 2.

14. A comprising according to claim 2 which is a personal care preparation, oral hygiene formulation or washing and cleaning formulation.

15. An anti-dandruff composition according to claim 14.

16. A composition according to claim 1 which comprises a natural or synthetic polymer.

17. A composition according to claim 1 which is a woven or non woven textile, paper product, coating composition or plastic article.

18. A method for cleaning and disinfecting hard surfaces which comprises applying a composition according to claim 1.

19. A method for preventing bio-fouling of an article comprising incorporating the compounds of formula I according to claim 2 into the article or surface of the article either directly or as part of a coating or film.

20. An anti-microbial compound of formula Id, II, III or IV 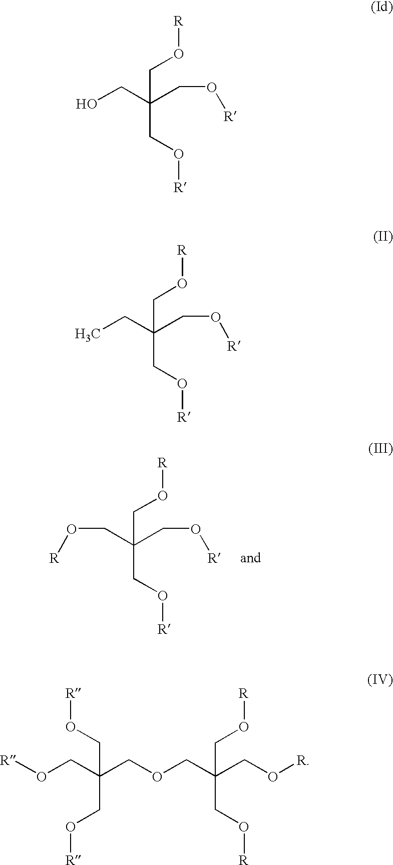
wherein each R′ is independently H or a group R,
each R is independently C₁₋₂₄ alkyl or C₁₋₂₄ alkylcarbonyl which is interrupted one or more times by —O—, —N(R″)— or —CON(R″)—, and/or substituted by one or more —NR″R″, halogen, ammonium salt, —COOM, -L-Ar, 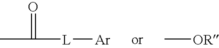
wherein each R″, independently of any other R″ is H, C₁₋₂₄ alkyl, C₃₋₂₄ alkenyl or C₁₋₂₄ alkylcarbonyl which are uninterrupted or interrupted one or more times by one or more oxygen atoms, carbonyl, —COO—, —CONH—, —NH—, —CON(C₁₋₂₄ alkyl)- or —N(C₁₋₂₄ alkyl)-, which uninterrupted or interrupted alkyl, alkenyl, or alkylcarbonyl are unsubstituted or substituted one or more times by one or more groups selected from halogen, —OH, C₂₋₂₄ alkylcarbonyl, C₁₋₂₄alkoxy, C₂₋₂₄alkylcarboxy, —COOM, —CONH₂, —CON(H)(C₁₋₂₄ alkyl), —CON(C₁₋₂₄ alkyl)₂, —NH₂, —N(H)(C₁₋₂₄ alkyl), —N(C₁₋₂₄ alkyl)₂, —SO₃M, phenyl, phenyl substituted one or more times by one or more C₁₋₈ alkyl, naphthyl, naphthyl substituted one or more times by one or more C₁₋₈ alkyl, ammonium salt, phosphonic acid, phosphonate salt, or when two R″ are attached to a nitrogen atom they may form, together with the nitrogen atom to which they are attached, form a 5-, 6- or 7-membered ring which is uninterrupted or interrupted by —O—, —NH— or —N(C₁₋₁₂ alkyl)-; or R″ is a group [chemical structure]
